(19) United States
(12) Patent Application Publication
(10) Pub. No.: US 2017/0364957 A1
(43) Pub. Date: Dec. 21, 2017

(54) IDENTIFYING TARGET AUDIENCE FOR CONTENT DISTRIBUTION BASED ON HISTORICAL USER ACTIVITY

(71) Applicant: Facebook, Inc., Menlo Park, CA (US)

(72) Inventors: Yuguang Wu, Santa Clara, CA (US); Yi Huang, Pleasanton, CA (US)

(21) Appl. No.: 15/184,246

(22) Filed: Jun. 16, 2016

(51) Int. Cl. G06Q 30/02

(52) U.S. Cl. CPC G06Q 30/0269; G06Q 30/0255

(57) ABSTRACT

An online system identifies target audience for distributing content items based on historical activity of users. The online system receives information describing events representing actions of users performed on the online system or on an external system and stores the information as action logs. The online system receives targeting criteria specified as expressions, for example, expressions specifying aggregate values determined over a plurality of actions of a user. The online system retrieves events from the action logs and determines partial results based on expressions representing the targeting criteria. If the partial results for a user indicate that the user satisfies the targeting criteria, the online system selects the user for targeting the corresponding content item. The online system may process events in batches.

### BACKGROUND

This disclosure relates generally to content distribution by online systems, and in particular to identifying the target audience for content distribution based on historical user activities.

Content providers want to target their content towards a specific audience. There is a cost associated with sending content to a user. If a content provider sends the content to a user that is not interested in the content, the content provider wastes resources.

Conventional techniques of targeting users with specific content specify simple targeting criteria, for example, gender, age groups, and the like. As a result, the set of users that is provided with the content often includes a significant percentage of users that are not interested in the content.

Content providers would like to specify more sophisticated targeting criteria for identifying target audience based on non-trivial expressions. Conventional techniques are unable to efficiently identify users that satisfy complex targeting criteria. As a result, content providers are unable to direct content to the right audience.

### SUMMARY

An online system receives content items and targeting criteria for determining target audience for each content item. The online system stores action logs describing events associated with users. For example, the online system may receive information from an external system describing actions performed by a user on the external system, and store an action log describing the action. The online system stores a results table mapping user identifiers (IDs) to partial results determined based on targeting criteria associated with each content item. The online system processes events stored in the action logs. For each event processed, the online system updates the partial result based on the event for the user associated with the event, if the event is associated with targeting criteria for a content item. The online system determines if a user satisfies the targeting criteria based on a partial result value. If the user satisfies the targeting criteria based on the partial result value, the online system sends information describing the content item to a client device of the user.

In an embodiment, the online system processes events stored in the action logs as batches. Accordingly, the online system loads a batch at a time and processes events of the bath to update partial results associated with the user. The online system may determine the size of the batch based on a size of memory available to store the batch.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a system overview for identifying target audience for content distribution based on historical user activity, content provider system, and client devices.

FIG. 2 is a block diagram of an architecture of an online system for identifying target audience for content distribution based on historical user activity, in accordance with an embodiment.

FIG. 3 is a flowchart of the process for identifying target audience for content distribution based on historical user activity, in accordance with an embodiment.

FIG. 4 illustrates various data structures used by the analyzer module and their interactions, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

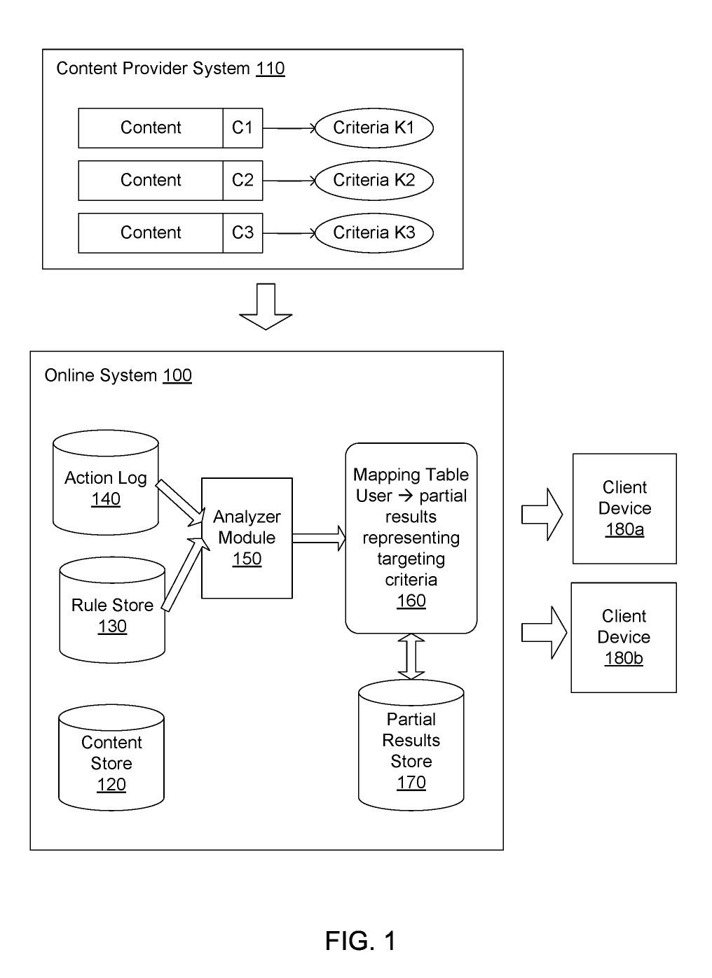

FIG. 1 is a system overview for creating target audience for content distribution based on historical user activity. The overall system illustrated in FIG. 1 includes an online system, one or more content provider system, and client devices. The online system 100 receives content items from a content provider system 110. The online system 100 also receives for each content item, criteria for determining target audience for each content item. The online system 100 identifies users of the online system that satisfy the criteria for a given content item and displays the corresponding content item to the identified users via their client devices 180. In an embodiment, the content item is a sponsored content item or a promotional content item for which the online system receives compensation from the content provider for distributing the content item.

FIG. 1 and the other figures use like reference numerals to identify like elements. A letter after a reference numeral, such as “180a,” indicates that the text refers specifically to the element having that particular reference numeral. A reference numeral in the text without a following letter, such as “180,” refers to any or all of the elements in the figures bearing that reference numeral (e.g. “180” in the text refers to reference numerals “180a” and/or “180b” in the figures).

In an embodiment, the content provider system 110 is a vendor that provides a content item associated with a product or service and targeting criteria for identifying users that are likely to be interested in the product or service. In another embodiment, the content provider system 110 is a publisher distributing content to various types of users.

The online system 100 includes a content store 120, a rule store 130, an action log 140, an analyzer module 150, a mapping table 160, and a partial results store 170. The online system 100 receives criteria K1, K2, and K3 for targeting different content items C1, C2, and C3 from the content provider system 110. The criteria K1, K2, and K3 are used by the online system 100 to identify users to present corresponding content items C1, C2, C3 from the content provider system 110.

The online system 100 allows the content provider system 110 to specify complex targeting criteria, for example, expressions based on past user activity. The online system 100 is configured to identify users that satisfy these targeting criteria. For example, the online system 100 can identify users that satisfy criteria targeting users that have performed a specific type of actions, for example, spending more than a certain amount of time on a website, visiting a web site more than a certain number of times, spending more than a certain amount on a website. Targeting criteria may specify an aggregation function, for example, a sum, a count, a product, a maximum value, a minimum value from a plurality of values. In an embodiment, the online system 100 identifies users that satisfy a given targeting criteria based on an aggregation function determined over a plurality of user actions. For example, the targeting criteria may specify that the content item should be distributed to users who have visited a website or a web page more than a certain number of times, visitors who have performed certain types of transactions, for example, purchases more than a threshold number of times, users who have performed more than a threshold number of interactions of certain type within a time interval of a given length, and so on.

The content received by the online system 100 from the content provider system 110 may be a text, image, audio, video, or any other suitable data for presentation to a user. The online system 100 stores the criteria K1, K2, and K3 in the rule store 120 and the content items C1, C2, and C3 in the content store 130. The action log 140 contains data of actions that users take such as visiting a webpage, placing something in a shopping cart, putting items in a wish list, purchasing an item, etc. The action log 140 may also store information received by the online system 100 from external systems, for example, external websites describing actions performed by users of the online system 100 on the external systems. Web pages of external websites execute instructions in response to user actions to send information describing these actions to the online system 100.

The online system 100 reads events from the action log 140 into memory. In an embodiment, the online system 100 reads events from the action log 140 as batches and processes them one batch at a time. The analyzer module 150 analyzes the events by grouping events based on a map of linear arrays keyed on a user (or any other structure used for representing a set of users, for example, a hash table). The analyzer module 150 iterates through events for each user in the map, and accumulates intermediate results for targeting criteria associated with one or more content items according to their aggregation function. The mapping table 160 maps the user to a value indicating whether user satisfies target criteria K1, K2, and K3, computed by the analyzer module 150. The partial results store 170 is updated with the entries of mapping table 160. Based on the results of the analysis from the analyzer module 150, the online system 100 determines if targeting criteria is met for a user of the online system and displays content via client devices 180 to users that meet the targeting criteria.

The partial results store 170 ensures that the online system 100 does not lose significant processing time in case of system crashes. For example, the online system 100 stores partial results intermittently and stores a marker identifying a sequence number of a log that was last processed for which the partial results were stored in the partial results store 170. In case of system crashes, the online system 100 loses data that was stored in memory. The online system 100 is able to resume processing from the log identified by the marker instead of having to restart the processing from the beginning. Accordingly, the amount of processing that the online system has to redo is significantly less compared to a system that is required to restart from the beginning. The amount of processing that the online system 100 has to redo depends on how frequently the system stores partial result in the partial results store 170. If the online system 100 stores the partial results frequently, the amount of data lost in case of system crashes is less.

### System Architecture

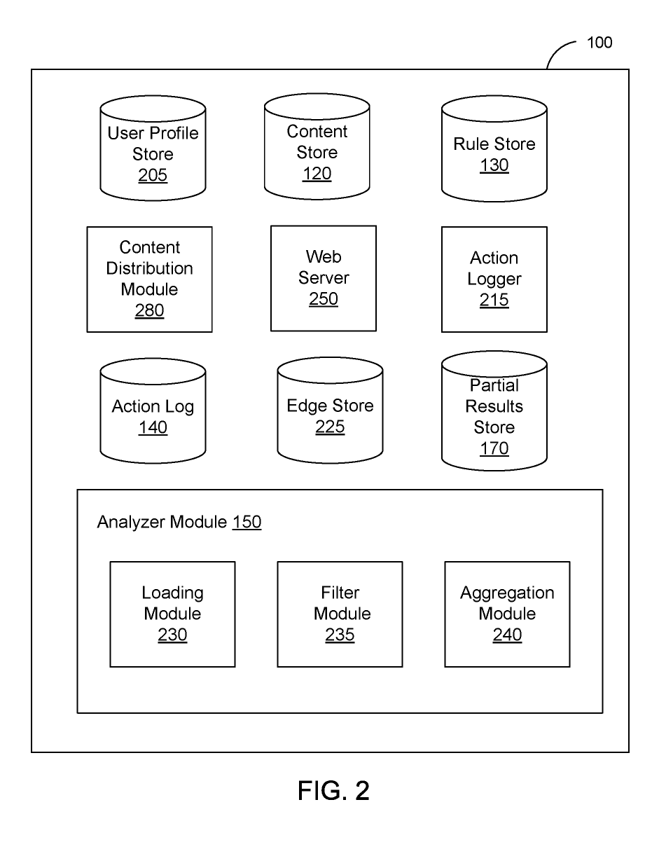

FIG. 2 is a block diagram of an architecture of an online system, in accordance with an embodiment. The online system 100 shown in FIG. 2 includes a user profile store 205, a content store 120, an edge store 225, a rule store 130, an action logger 240, an action log 140, an analyzer module 150, a web server 250, a partial results store 170, and a content distribution module 280. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

Each user of the online system 100 is associated with a user profile, which is stored in the user profile store 205. A user profile includes declarative information about the user that was explicitly shared by the user and may also include profile information inferred by the online system 100. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 120 and stored in the action log 140.

While user profiles in the user profile store 205 are frequently associated with individuals, allowing individuals to interact with each other via the online system 100, user profiles may also be stored for entities such as businesses or organizations. This allows an entity to establish a presence on the online system 100 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 120 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 120, such as status updates, photos tagged by users to be associated with other objects in the social networking system, events, groups or applications. In some embodiments, objects are received from third-party applications or third-party applications separate from the online system 100. For example, objects are received from the content provider system 110 include content which may include advertising content or content from a publisher associated with targeting criteria. In one embodiment, objects in the content store 120 represent single pieces of content, or content “items.” Hence, social networking system users are encouraged to communicate with each other by posting text and content items of various types of media to the online system 100 through various communication channels. This increases the amount of interaction of users with each other and increases the frequency with which users interact within the online system 100.

In one embodiment, the edge store 225 stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 100, such as expressing interest in a page on the online system 100, sharing a link with other users of the online system 100, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 100, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 100 over time to approximate a user's interest in an object or another user in the online system 100 based on the actions performed by the user. A user's affinity may be computed by the online system 100 over time to approximate a user's interest for an object, interest, or other user in the online system 100 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The rule store 130 stores targeting criteria from the content provider system 110. In an embodiment, the online system 100 represents targeting criteria using a language that supports a syntax specifying expressions. These expressions include mathematical expressions, logical expressions, and aggregate functions among others as well as combinations of various types of expressions. In an embodiment, the online system 100 represents targeting criteria using markup language that allows use of tags to specify various operators and operands of an expression. The rule store 130 associates each targeting criteria with an identifier for uniquely identifying the targeting criteria. The online system 100 uses the identifier for a targeting criterion to associate a targeting criterion with one or more content items stored in the content store 120.

In one embodiment, the online system 100 processes targeting criteria that specify user actions performed via the online system 100 or types of connections between a user and another user or object of the online system 100. Targeting criteria may also specify interactions between a user and objects performed external to the online system 100, such as on a third party system. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system, or any other suitable action. Including actions in targeting criteria allows content provider systems 110 to further refine users eligible to be presented with content. As another example, targeting criteria identifies users having a connection to another user or object or having a particular type of connection to another user or object. Hence, targeting criteria allow a content provider system 110 to identify users having specific characteristics, allowing the content provider system 110 to present users with content in which the user is more likely to have an interest.

In one embodiment, targeting criteria may specify actions or types of connections between a user and another user or object of the online system 100. For example, targeting criteria may specify the number of times keywords associated with a topic (product, vendor) were mentioned in communications by the user with the user's connections. In another example, the targeting criteria may specify an average affinity score of connections of the user that have been previously identified as being a target audience for the content.

In one embodiment, targeting criteria specifies interactions between a user and objects performed external to the online system 100, such as on a third party system. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system, or any other suitable action. Another targeting criteria specifies the average amount of money spent by connections of the user on products of a certain type. Accordingly, a content item is targeted to the user if the average amount of money spent by the connections of the user on products of that particular type is more than a threshold value. Including actions in targeting criteria allows content providers to refine users eligible to be presented with content. As another example, targeting criteria identifies users having a connection to another user or object or having a particular type of connection to another user or object.

The action logger 215 receives communications about user actions internal to and/or external to the online system 100, populating the action log 140 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 140.

The action log 140 stores information describing actions taken by users. Each action log is represented as a tuple: (user_id, time_stamp, action_type, properties) where user_id identifies the user that performed the action, time_stamp is the time the action was performed, action_type is the type of action performed, and properties are name value pairs representing information describing the action. For example, if the action_type is purchasing, the properties specify the items purchased, the cost of each item total amount paid, shipping information, and so on; if action type is performing search, the properties specify the search terms, any preferences specified for the search, for example, order in which results are requested, etc.

The action log 140 may be used by the online system 100 to track user actions on the online system 100, as well as actions on third party systems that communicate information to the online system 100. Users may interact with various objects on the online system 100, and information describing these interactions is stored in the action log 140. Examples of interactions with objects include: commenting on posts, sharing links, checking-in to physical locations via a mobile device, accessing content items, and any other suitable interactions. Additional examples of interactions with objects on the online system 100 that are included in the action log 140 include: commenting on a photo album, communicating with a user, establishing a connection with an object, joining an event, joining a group, creating an event, authorizing an application, using an application, expressing a preference for an object (“liking” the object), and engaging in a transaction, for example, to purchase an item via the online system. Additionally, the action log 140 may record a user's interactions with advertisements on the online system 100 as well as with other applications operating on the online system 100. In some embodiments, data from the action log 140 is used to infer interests or preferences of a user, augmenting the interests included in the user's user profile and allowing a more complete understanding of user preferences.

The action log 140 may also store user actions taken on a third party system, such as an external website, and communicated to the online system 100. For example, an e-commerce website may recognize a user of an online system 100 through a social plug-in enabling the e-commerce website to identify the user of the online system 100. Because users of the online system 100 are uniquely identifiable, e-commerce websites, such as in the preceding example, may communicate information about a user's actions outside of the online system 100 to the online system 100 for association with the user. Hence, the action log 140 may record information about actions users perform on a third party system, including webpage viewing histories, advertisements that were engaged, purchases made, and other patterns from shopping and buying.

In an embodiment, the an external website includes tracking pixels in the web pages provided by the external website such that when the web page is presented via the client device 180, a particular program or code (or set of instructions) is executed by the client device 180. In an embodiment, this code associated with the pixel causes a request to be sent to the online system 100 providing information describing the web page presented to the user. A tracking pixel may be a transparent 1×1 image, an iFrame, or other suitable user interface object. The request set to the online system 100 includes information describing a type of action performed by the user, for example, viewing certain content via the web page. The online system 100 stores the information describing the action performed by the user in the action log 140.

The web server 250 links the online system 100 via the network to the one or more client devices 180, as well as to the one or more third party systems. The web server 250 serves web pages, as well as other content, such as JAVA®, FLASH®, XML and so forth. The web server 250 may receive and route messages between the online system 100 and the client device 180, for example, instant messages, queued messages (e.g., email), text messages, short message service (SMS) messages, or messages sent using any other suitable messaging technique. A user may send a request to the web server 250 to upload information (e.g., images or videos) that are stored in the content store 120. Additionally, the web server 250 may provide application programming interface (API) functionality to send data directly to native client device operating systems, such as IOS®, ANDROID™, WEBOS® or BlackberryOS.

The analyzer module 150 determines whether to send content from a content provider system 110 to a user by computing aggregate values associated with one or more targeting criteria applied to the user actions from the action log 140. The analyzer module 150 includes a loading module 230, a filter module 235, and an aggregation module 240. The loading module 230 loads entries from the action log 140 to memory. In an embodiment, the loading module 230 loads a batch of entries from the action log at a time. The analyzer module 150 processes the batch of entries loaded and then invokes the loading module 230 to load the next batch of entries. In an embodiment, the action log 140 stores the action logs sorted based on a timestamp associated with each log. The loading module 230 traverses the action logs in the order in which the action logs are sorted for processing them.

In some embodiments, the action logs are stored in compressed form in the action logger 215. In some embodiments, the online system 100 represents action logs in a compressed form in memory when online system loads action logs in memory. The online system represents information describing each action log using a compact representation so as to maximize the number of action logs that can be stored in memory. Accordingly the number of action logs processed in each batch is larger if the online system represents each action log using a compact representation.

The filter module 235 filters the entries of the action log 140 for a user. For example, to aggregate certain value over a plurality of action logs, the filter module 235 filters and identifies the action logs corresponding to the user. The filter module 235 passes the filtered set of action logs for the user to the aggregation module 240 to perform an aggregation. In an embodiment, each action log is associated with a user identifier for a user that performed the action. The filter module 235 uses the user identifier for the action logs to filter the action logs.

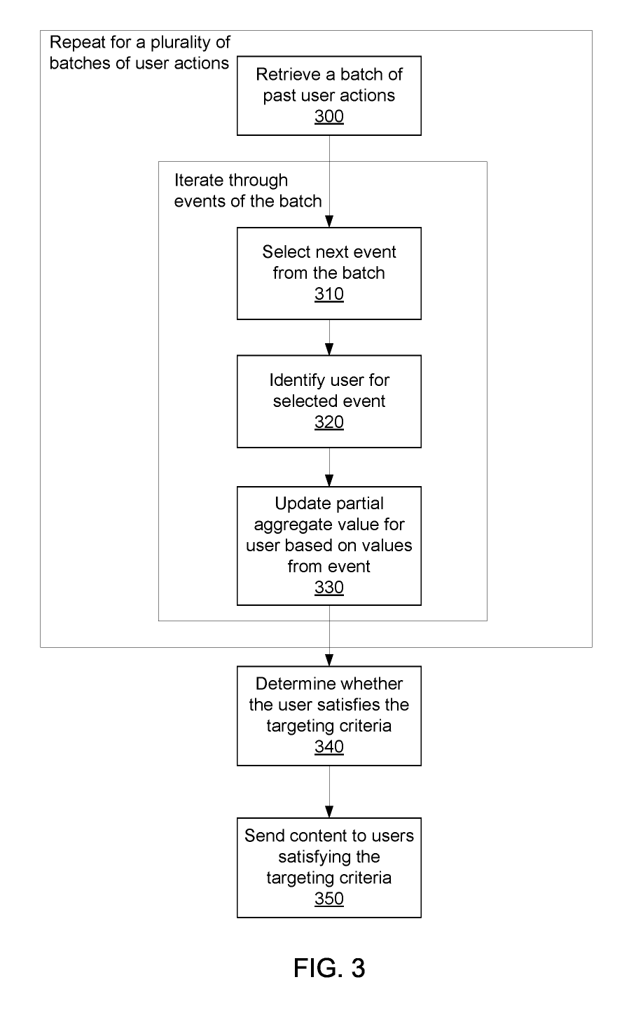

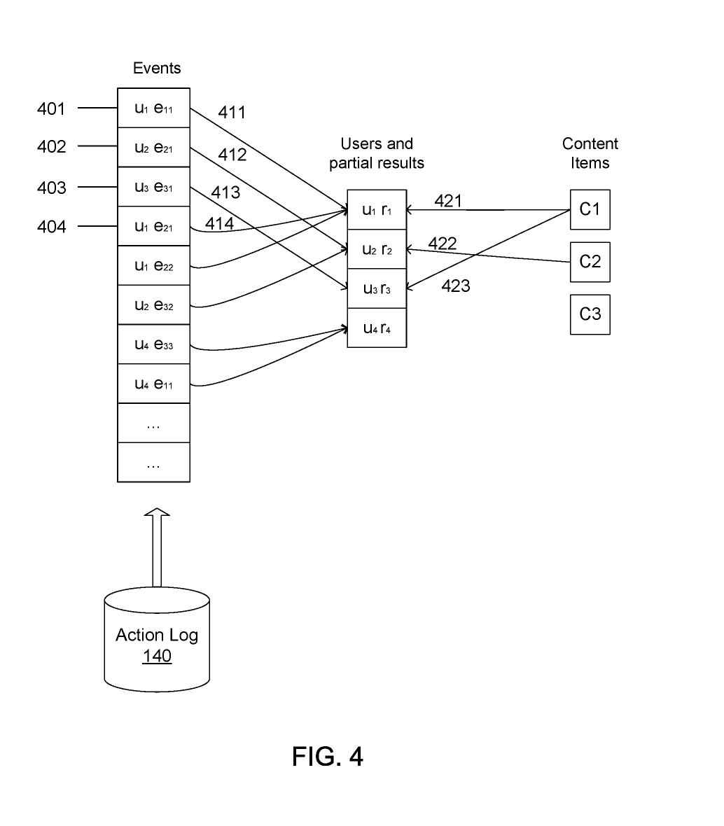

The aggregation module 240 computes a value based on aggregation functions for each user and stores this value as a score in a mapping table 160. The mapping table 160 maps each user to a score, the score indicates whether the user satisfies target criteria. For example, the aggregation function may be an average, e.g. the average amount of time spent on a website per visit or the average amount of money spent on transactions. The aggregation function may be a count, e.g. a count of how many times an action of a certain type is performed. The aggregation function may be a maximum, e.g., the maximum amount of money spent by the user on a transaction on a website. The aggregation function may be a minimum, e.g. the minimum amount of time spent on a website before a purchase was made. The aggregation function may be a sum, e.g. the sum of the amount of money spent on products of a certain type. The aggregation function may be a weighted aggregate of different types of actions, e.g. the sum of the count of views multiplied by a first weighting, the average time spent on websites multiplied by a second weighting, and the maximum amount spent on a website multiplied by a third weighting. Different types of actions are associated with different types of weights, indicative of how interested a user is in an item. For example, purchasing certain types of items is given higher weight than viewing certain type of content or performing search. The aggregation function may be a combination of expressions, e.g. users having count, sum, or maximum greater than a specific value. The analyzer module 150 will be described in more detail in FIG. 3 and FIG. 4.

Partial results store 170 stores one or more unique user IDs and corresponding partial aggregate value based on one or more rules supplied to user actions from the action log. For example, if the event being processed is performed by a new user that does not exist in partial results store 170, a new user and associated aggregation value is stored in the partial results store 170. If the event being processed is performed by a user that already exists in the partial results store 170, the updated aggregation value is stored with the existing user in the partial results store 170.

Content distribution module 280 sends one or more content items to users determined to satisfy the corresponding targeting criteria. For example, the criteria K1 is that the average amount of money spent on products of a certain type is falls within a specified range of prices. The content C1 is content for a new product that also falls within the specified range of prices. The aggregation function may be the average amount of money spent on products of a certain type. The partial results store 170 stores the partial result of the aggregation value for a list of users. The content distribution module 280 analyzes the entries in the partial results store 170 for users with aggregation value that satisfy criteria K1 and sends content C1 to users who satisfy the criteria K1.

### Overall Process

FIG. 3 is a flowchart for the analyzer module, in accordance with an embodiment. In one embodiment, the analyzer module 150 reads all past user actions from the action log 140, provided all past user actions fit in memory of the computer processors performing the process indicated in FIG. 3. In another embodiment, the analyzer module 150 reads batches of past user actions and processes one batch of user actions at a time. The analyzer module 150 continues reading batches of past user actions and processing them until all past user actions are analyzed. The analyzer module 150 retrieves 300 a batch of past user actions from the action log 140 into memory for fast access. For each batch, the analyzer module 150 iterates through the events of each batch by selecting 310 the next event from the batch, identifying 320 the user for the selected event, updating 330 a partial aggregate value for the user based on values from the event, and determining 340 whether the user satisfies the targeting criteria. Alternatively, the analyzer module 150 may first group events into individual user categories and then process events for each user separately. When the analyzer module 150 completes analysis of user actions, the content distribution module 280 sends 350 the content item to users satisfying the target criteria. In an embodiment, although not shown in FIG. 3, the analyzer module 150 provides information identifying a user as soon as the analyzer module 150 determines that the user satisfies the targeting criteria, thereby allowing the content distribution module 280 to sends the content item to the user.

In an embodiment, the online system 100 stores the partial aggregate values using a mapping table 160 that maps user IDs to partial result values. The analyzer module 150 may represent the mapping table as a data structure configured to store a set, for example, an array data structure or a list data structure. If the analyzer module 150 represents the mapping table as an array, each user is mapped to an index of the array using a hash function. For example, the analyzer module 150 applies a hash function to the user ID or other attributes of the user to arrive at an index value. The analyzer module 150 stores the user information in an element of the array identified by the index value. Ideally, each index of the array represents a single user. However, the hash function may be imperfect and multiple users may map to the same index of the array. The analyzer module 150 represents each element of the array as an ordered list since multiple users may map to the same index of the array.

FIG. 4 illustrates operations associated with the analyzer module, in accordance with an embodiment. The analyzer module 150 reads a batch of actions or events (e.g. event 401, event 402, event 403, event 404) from the action log 140. The events from the action log 140 include a user ID (e.g., u₁, u₂, u₃, u₄) and information associated with the event such as time stamp, action type and properties (e.g., e₁₁, e₂₁, e₃₁, e₂₁). The analyzer module 150 sorts the events by user ID. For example, events 401, 402, and 403 are performed by different users: u₁, u₂, and u₃. Thus, the analyzer module 150 computes aggregate values for each event 401, 402, and 403 based on the information associated with the event e₁₁, e₂₁, e₃₁, and stores the partial aggregate value as r₁, r₂, and r₃ with each user ID, as shown by arrow 411, arrow 412, and arrow 413. Event 404 is performed by the same user u₁ as event 401. Thus, the analyzer module computes a new aggregate value for user u₁ based on the previous aggregate value r₁ and the information e₂₁ associated with event 404, and stores the updated partial aggregate value as r₁ with user u₁, as shown by arrow 414.

The online system 100 may process multiple targeting criteria at the same time. Accordingly, the online system 100 may update several partial results representing targeting criteria in a single pass through a set of action logs. For example, if an event of a particular type is specified in multiple targeting criteria, if the online system 100 loads that event, the online system processes all the targeting criteria for that user that are associated with the event.

In an embodiment, the online system 100 creates a new entry for a user in the mapping table 100 when the online system encounters an action log for that user for the first time. Accordingly, the online system 100 checks if an entry for the user exists in the mapping table 160. If the entry exists, the online system 100 uses the entry, or else the online system 100 creates a new entry.

In an embodiment, the online system 100 identifies sets of content items as related content items. All content items of a set are determined to be associated with each other based on certain criterion. If the online system 100 presents a particular content item from a set to a user, the online system 100 withholds the remaining content items of the set from being presented to the user at least for a predetermined time interval even if the user satisfies the targeting criteria for one or more content items from the set. For example, a set of content items may present information about the same topic. Accordingly, if the online system 100 presents a user with one content item on the topic, the online system 100 waits for at least a predetermined time interval before presenting another content item on the same topic. In an embodiment, the content items are sponsored content items describing a product or service. If the online system 100 presents a sponsored content item associated with a product or service, the online system 100 waits for at least a threshold time interval before displaying another sponsored content item to that user for the same product or service.

In an embodiment, the analyzer module 150 associates each user in the mapping table 160 with one or more sets of content items. The online system 100 also associates each set of content items with a threshold time T such that if a content item C1 from a set is presented to a user, another content item C2 is not presented to the user for at least T time. The analyzer module 150 also stores a timestamp for each set of content item associated with the user. A set of content items is associated with the user if a content item from the set is presented to the user. The timestamp associated with the set for the user indicates a time at which the content item was presented to the user. If the online system 100 identifies a content item for presentation to the user at a subsequent time, the online system 100 checks if the content item belongs to a set associated with the user in the mapping table 160. If the online system 100 determines that the content item belongs to a set associated with the user, the online system determines the timestamp t of the set for the user and the threshold time T for the set. The online system 100 checks if more than the threshold time T has passed since the time t indicated by the timestamp of the set for the user. If the online system 100 determines that more than the threshold time T has passed since the time t, the online system presents the content items to the user and also resets the time t to be the current time. In an embodiment, the online system 100 checks periodically if a set associated with a user has a timestamp t that is older than the threshold time T for the set. If the online system determines that a set associated with a user has a timestamp t that is older than the threshold time T for the set, the online system 100 disassociates the set from the user. Accordingly, if the online system 100 subsequently selects a content item from the set for presentation to the user, the online system 100 does not withhold the content item from the user and presents the content item to the user.

In an embodiment, the online system 100 associates a set with a user by storing an identifier for the set in association with the user. The online system 100 determines an identifier for a set based on some characteristics for the set. For example, if a set represents sponsored content items for a product or service, the online system 100 uses information associated with the product or service as an identifier for a set. For example, the online system 100 may store the name of the product or n identifier for the product, for example, a SKU (stock keeping unit) in association with the user to associate the user with sponsored content items for the product.

### Alternative Embodiments

The foregoing description of the embodiments have been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

What is claimed is:

1. A computer-implemented method comprising:
receiving, from a content provider system, one or more content items and one or more targeting criteria for determining target audience for each of the one or more content items;
storing, by an online system, action logs describing user actions, each action log storing a user identifier (ID) and information describing an event;
storing, by the online system, a mapping table mapping user IDs to partial results, each partial result determined based on the one or more targeting criteria associated with a content item;
processing, by the online system, a plurality of batches of events, the processing of each batch comprising:
reading the batch of events from the action logs; and
for each event in the batch of events:
identifying a user ID for a user that performed the event;
determining if the event is associated with the one or more targeting criteria associated with a content item;
accessing a partial result value from the mapping table for the user ID;
determining an aggregation value based on the event and the partial result value associated with the user ID;
updating the partial result value associated with the user ID in the mapping table based on the aggregation value;
determining, from the aggregation value associated with the user ID, if the user satisfies the one or more targeting criteria associated with a content item received from the content provider system; and
sending, to a client device of the user, information describing the content item, if the user is determined to satisfy the one or more targeting criteria.

2. The computer-implemented method of claim 1, further comprising:
identifying sets of content items;
responsive to presenting a user with a content item, associating the user with a set associated with the content item; and
withholding content items of the set of content items from the user for at least a threshold time interval after presenting the content item.

3. The computer-implemented method of claim 1, further comprising:
determining a size of a batch based on a size of memory of a processor executing the computer-implemented method.

4. The computer-implemented method of claim 1, wherein the aggregation value is determined using a count, a maximum, a minimum, a sum, a weighted average, or a combination of expressions.

5. The computer-implemented method of claim 1, wherein an event comprises one of: viewing a particular content item, performing searches, or performing actions related to certain products.

6. The computer-implemented method of claim 1, wherein the plurality of batches of events represent the most recent events stored in the action logs.

7. The computer-implemented method of claim 1, wherein the plurality of batches of events represent all the events stored in the action logs.

8. The computer-implemented method of claim 1, wherein processing the batch of events further comprises, for each event in the batch of events:
creating a new entry in a mapping table if the event is performed by a user ID not existing in the mapping table.

9. The computer-implemented method of claim 1, wherein an action log represents an action performed by the user on an external system via a client device, wherein the online system receives information describing the action from the client device as a result of a pixel displayed on the client device by the external system.

10. A computer-implemented method comprising:
receiving, from a content provider system, one or more content items and one or more targeting criteria for determining target audience for each of the one or more content items;
storing, by an online system, action logs describing user actions, each action log storing a user identifier (ID) and information describing an event;
storing, by the online system, a mapping table mapping user IDs to partial results, each partial result determined based on the one or more targeting criteria associated with a content item;
processing, by the online system, events stored in the action logs, the processing of each event comprising:
identifying a user ID for a user that performed the event;
determining if the event is associated with the one or more targeting criteria associated with a content item;
accessing a partial result value associated with the one or more targeting criteria from the mapping table for the user ID;
determining an aggregation value based on the event and the partial result value accessed;
updating the partial result value associated with the user ID in the mapping table;
determining, from the aggregation value associated with the user ID, if the user satisfies the one or more targeting criteria associated with a content item received from the content provider system; and
sending, to a client device of the user, information describing the content item, if the user is determined to satisfy the one or more targeting criteria.

11. The computer-implemented method of claim 10, further comprising:
identifying sets of content items;
responsive to presenting a user with a content item, associating the user with a set associated with the content item; and
withholding content items of the set of content items from the user for at least a threshold time interval after presenting the content item.

12. The computer-implemented method of claim 10, further comprising:
determining a size of a batch based on a size of memory of a processor executing the computer-implemented method.

13. The computer-implemented method of claim 10, wherein the aggregation value is determined using a count, a maximum, a minimum, a sum, a weighted average, or a combination of expressions.

14. The computer-implemented method of claim 10, wherein an event comprises one of: viewing a particular content item, performing searches, or performing actions related to certain products.

15. The computer-implemented method of claim 10, wherein the plurality of batches of events represent the most recent events stored in the action logs.

16. The computer-implemented method of claim 10, wherein the plurality of batches of events represent all the events stored in the action logs.

17. The computer-implemented method of claim 10, wherein processing the batch of events further comprises, for each event in the batch of events:
creating a new entry in a mapping table if the event is performed by a user ID not existing in the mapping table.

18. The computer-implemented method of claim 10, wherein an action log represents an action performed by the user on an external system via a client device, wherein the online system receives information describing the action from the client device as a result of a pixel displayed on the client device by the external system.

19. A non-transitory computer storage medium storing instructions for:
receiving, from a content provider system, one or more content items and one or more targeting criteria for determining target audience for each of the one or more content items;
storing, by an online system, action logs describing user actions, each action log storing a user identifier (ID) and information describing an event
storing, by the online system, a mapping table mapping user IDs to partial results, each partial result determined based on the one or more targeting criteria associated with a content item;
processing, by the online system, a plurality of batches of events, the processing of each batch comprising:
reading the batch of events from the action logs; and
for each event in the batch of events:
identifying a user ID for a user that performed the event;
accessing a partial result value from the mapping table for the user ID;
determining an aggregation value based on the event and the partial result value associated with the user ID;
updating the partial result value associated with the user ID in the mapping table;
determining, from the aggregation value associated with the user ID, if the user satisfies the one or more targeting criteria associated with a content item received from the content provider system; and
sending, to a client device of the user, information describing the content item, if the user is determined to satisfy the one or more targeting criteria.

20. The non-transitory computer storage medium of claim 1, further storing instructions for:
identifying sets of content items;
responsive to presenting a user with a content item, associating the user with a set associated with the content item; and
withholding content items of the set of content items from the user for at least a threshold time interval after presenting the content item.
